(19) United States
(12) Patent Application Publication
(10) Pub. No.: US 2007/0112973 A1
(43) Pub. Date: May 17, 2007

(54) Pre-cached streaming content method and apparatus

(76) Inventors: John M. Harris, Chicago, IL (US); Rajesh S. Pazhyannur, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 11/280,520

(22) Filed: Nov. 16, 2005

(51) Int. Cl. G06F 15/16

(52) U.S. Cl. 709/232

(57) ABSTRACT

A communication device (400) responds to detecting a likely streaming content downloading event by dynamically determining (102) an amount of the streaming content to locally pre-cache prior to detecting an instruction (105) to download the streaming content and to then pre-cache (104) that amount. This determination can be based (201) on a likely period of delay between detecting the instruction to download the streaming content and being able to being providing the streaming content to a user of the communication device. If desired, this determination can further be based (202) upon a potentially less favorable period of delay. In the latter case, if desired, the pre-cached streaming content as corresponds to a period of time between the likely period of delay and the less favorable period of delay can have an intentionally reduced quality as compared to the pre-cached streaming content as corresponds to the likely period of delay.

### TECHNICAL FIELD

This invention relates generally to the delivery of streaming content to a communication device.

### BACKGROUND

Streaming content is known in the art. Streaming content typically comprises content such as audio or video material that is preferably offered during playback as a substantially continuous presentation without obvious delays or interruptions. For example, when playing a musical piece, the user will usually prefer to hear the musical piece as a contiguous whole and without obvious gaps or delays in the musical piece.

When presenting streaming content via a packet based bearer (such as Internet Protocol-based conveyance mechanisms), however, considerable variability can occur with respect to the delivery of individual data packets. It is possible (even expected) that some packets will be considerably delayed with respect to their time of reception as compared to other packets as may have been transmitted at about the same time. It is even possible for earlier transmitted packets to arrive subsequent to later transmitted packets. Such temporal anomalies are often referred to as jitter.

To at least attempt to ameliorate the impact of such conditions, a certain quantity of received streaming content material is usually buffered prior to playback to hopefully ensure that an adequate quantity of material will remain available to provide a relatively constant feed for playback notwithstanding packet delivery jitter. While often effective to mitigate against such circumstances and to aid in providing the user with a continuous playback experience, this approach also necessarily contributes to considerable initial delay before that user can begin to perceive the streaming content. Depending upon system conditions and the kind of streaming content at issue, this delay can become considerable (comprising many seconds or even minutes in some systems).

There are also other causes of delay with respect to when streaming content begins playback. For example, channel establishment delay can potentially add considerably in this regard. Yet another potential cause of delay in this regard can correspond to time as may be required for the end user platform to signal in the first instance the need to begin receiving the streaming content.

Many users object to experiencing such an initial delay before playback begins. Such objections may be based upon concerns regarding whether the streaming process is in fact underway or can be based upon simple impatience. Regardless, such objections can discourage at least some users from availing themselves of otherwise available streaming services.

### BRIEF DESCRIPTION OF THE DRAWINGS

The above needs are at least partially met through provision of the pre-cached streaming content method and apparatus described in the following detailed description, particularly when studied in conjunction with the drawings, wherein:

FIG. 1 comprises a flow diagram as configured in accordance with various embodiments of the invention;

FIG. 2 comprises a detail flow diagram as configured in accordance with various embodiments of the invention;

FIG. 3 comprises an illustrative timeline example as configured in accordance with various embodiments of the invention;

FIG. 4 comprises a block diagram as configured in accordance with various embodiments of the invention; and

FIG. 5 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a communication device responds to detecting a likely streaming content downloading event by dynamically determining an amount of the streaming content to locally pre-cache prior to detecting an instruction to download the streaming content and then pre-caching that amount. This determination can be based, for example, on a likely period of delay between detecting the instruction to download the streaming content and being able to provide the streaming content to a user of the communication device. If desired, this determination can further be based upon a potentially less favorable period of delay. In the latter case, if desired, the pre-cached streaming content as corresponds to a period of time between the likely period of delay and the less favorable period of delay can have an intentionally reduced quality as compared to the pre-cached streaming content as corresponds to the likely period of delay.

So configured, upon then detecting an instruction to actually download the streaming content, the communication device can immediately begin to play back the pre-cached streaming content while, in the meantime, facilitating its normal actions to begin subsequently receiving the requested playback of the streaming content. If desired, the subsequent provision of streaming content can occur sans provision of the initial portion of streaming content as was already pre-cached. This, in turn, permits a user to rapidly begin experiencing the playback of the requested content notwithstanding that the streaming activity has not yet genuinely begun.

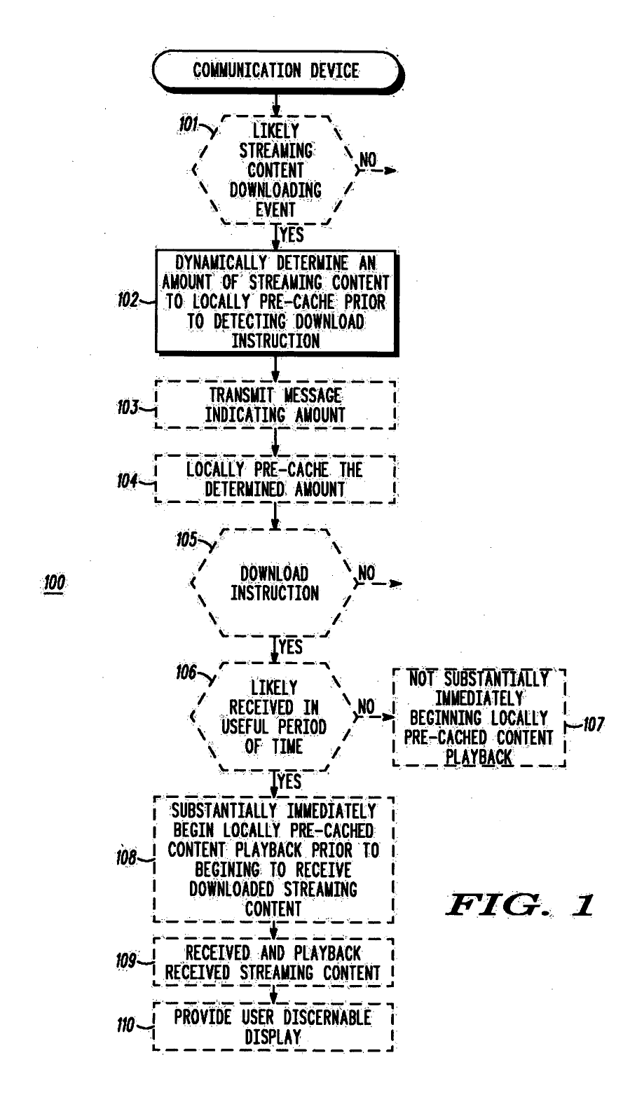

These and other benefits may become clearer upon making a thorough review and study of the following detailed description. Referring now to the drawings, and in particular to FIG. 1, a communication device, upon detecting 101 a likely streaming content downloading event, can respond by dynamically determining 102 an amount of the streaming content to locally pre-cache prior to detecting an instruction to download the streaming content to thereby provide a corresponding determined amount of streaming content. (Anticipatory capabilities to facilitate detecting a likely streaming content downloading event are known in the art and others will no doubt be developed in the future. These teachings are not particularly sensitive to the selection of any particular approach. Therefore, for all these reasons, and further for the sake of brevity and the preservation of narrative focus, additional elaboration with respect to ascertaining when a streaming content downloading event might occur will not be provided here.)

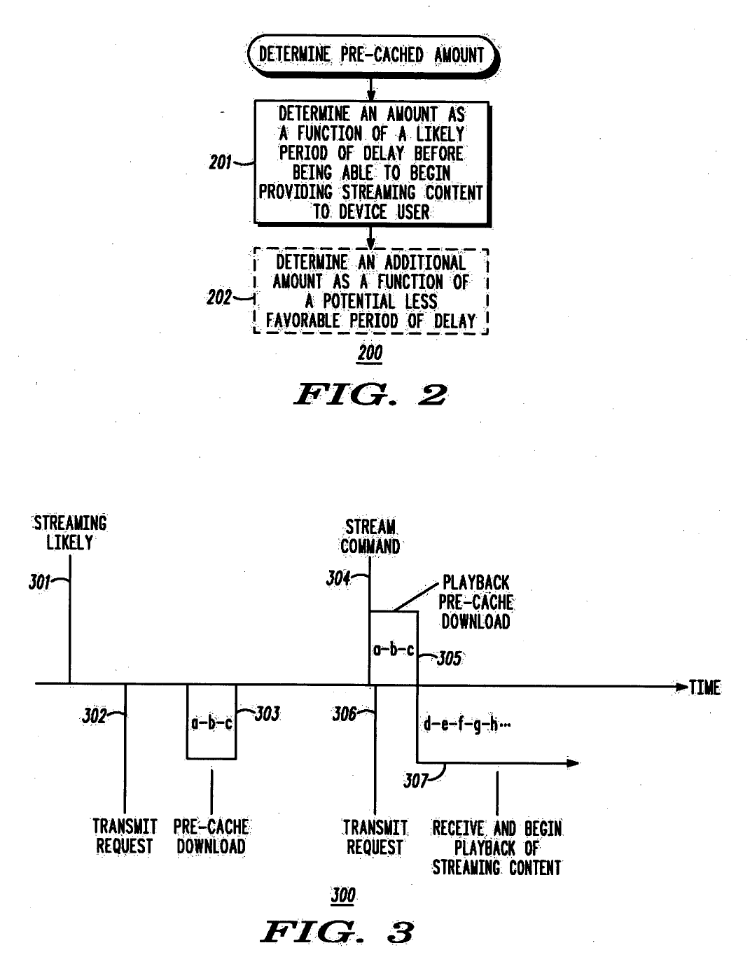

There are various approaches by which the amount of streaming content to locally pre-cache may be determined. By one simple approach this amount can simply comprise a fixed static amount. By another approach this amount can vary with one or more conditions of interest. By one approach, and referring momentarily to FIG. 2, this amount can be determined as a function, at least in part, of a likely period of delay between detecting an instruction to download the streaming content in question and being able to begin providing the streaming content to a user of the communication device. Various potential sources of such delay may be considered, including but not limited to delays associated with acquiring a communication channel (such as a wireless communication channel) to bear the streaming content, network message propagation latency, streaming content server response latency, jitter buffer filling requirements and/or limitations, playout buffer filling requirements and/or limitations, and so forth, to note but a few.

Such information can be gleaned in various ways using either local resources or remote resources as may be available to develop and/or otherwise provide such information. If desired, direct data regarding the criteria of interest may be used. Or, if desired, other data which tends to correlate in some known way with the criteria of interest may substitute for the latter when appropriate to thereby permit, for example, estimating or calculating through correlation, interpolation, and/or extrapolation useful values for the criteria of interest.

Optionally, if desired, this process 200 may also comprise determining 202 an additional amount of pre-cache streaming content. This additional amount can be determined, for example, as a function, at least in part, of a difference between the above-described likely period of delay and another value representing a potential less favorable period of delay. For example, while the likely period of delay (given a particular set of operational conditions as noted above) might be, in a given instance, 5 seconds, a potential less favorable period of delay would be some period of delay in addition to that 5 second period of delay. This value might be static (for example, a fixed additional period of delay of 6 seconds might be used) or dynamically determined. When dynamically determined, again, various criteria of interest can be used as desired to inform the determination process. By one approach, for example, this less favorable period of delay can be calculated using observed or derived worst case values as presently tend to characterize the streaming process while nevertheless still retaining some correspondence to actual network and device performance.

Returning again to FIG. 1, upon determining 102 an amount of streaming content to locally pre-cache, this process 100 can then optionally provide for transmission 103 of a message to indicate the determined amount of streaming content that is to be pre-cached. This message can be directed to, for example, a streaming content server that functions as a network access point for the streaming content of interest. By one approach, this message provides specific information regarding only that quantity of streaming content which the communication device now seeks to download.

When an extended quantity of streaming content is to be downloaded (as when a first quantity of streaming content as corresponds to a likely period of delay and a second quantity of streaming content as corresponds to an additional less favorable-case period of delay are both to be pre-cached) this information can reflect all such quantities. This, in turn, will permit, if desired, the streaming content server to provide the differing quantities of streaming content with different attendant quality levels. For example, the initial portion of the streaming content which corresponds to the expected initial period of delay may be provided at a relatively higher level of quality while the less favorable-case delay-based quantity might be provided at a relatively reduced level of quality.

This bifurcated treatment would provide numerous benefits. By providing the initial amount of streaming content at a higher quality level (one that might match, for example, a quality level as might be otherwise provided when streaming the content in ordinary course) the playback of the pre-cached streaming content will more likely appear relatively seamless when concatenated with the eventually received requested streaming broadcast. By providing this additional pre-cached streaming content (which serves the purpose of being available in the hopefully unlikely event that the initial pre-cached content is fully consumed prior to the streaming broadcast becoming fully available for playback) at a lower quality level this process may reduce network capacity requirements as are associated with supporting and facilitating these teachings. Or, in the alternative, a relatively larger quantity of surplus streaming content may be conveyed in a relatively shorter amount of time to, for example, ensure availability of a significant surplus of streaming content.

Upon receiving the requested streaming content, this process 100 then provides for locally pre-caching 104 the determined amount of streaming content. When a first and second portion of streaming content has been downloaded as described above, if desired, these two portions can be stored separately from one another or can be stored as a contiguous whole. The former approach will likely be preferred when the initial portion comprises higher quality content than the later portion.

This process 100 then optionally provides for detecting 105 an instruction to download the streaming content. This can comprise an instruction as may be entered by a user of the communication device, an instruction as may be prompted by an application being facilitated by the communication device, or via such other mechanism as may be desired or relevant in a given application setting. Upon detecting such an event, this process 100 can then optionally determine 106 whether the requested streaming content can now likely begin to be received at the communication device within a useful period of time.

In particular, this determination can ascertain whether, for example, the pre-cached streaming content is now likely still sufficient to bridge a temporal gap between now and when the requested streaming content becomes available. When it does not appear that the streaming content will become available in a useful time frame, this process 100 can then optionally provide for not substantially immediately responding 107 by beginning to play back the locally pre-cached streaming content prior to beginning to receive downloaded streaming content via, for example, the corresponding communication channel. Such an action may be appropriate, for example, when only one second of streaming content has been pre-cached as per these teachings but where circumstances have changed so that now ten seconds will likely be needed to begin receiving a current stream of content. For example, one may check to confirm that a usable network link appears to be available to support delivery of the streaming content. Under such conditions, it will likely not be appreciated by or helpful to the user to play an initial one second portion of the content only to follow that beginning with nine seconds or more of silence.

Upon determining that the follow-on streaming content will likely begin to become available within a useful period of time, or in lieu of making such a determination, this process 100 can then optionally substantially immediately 108 begin to play back the locally pre-cached streaming content prior to beginning to receive downloaded streaming content via the communication channel. While effecting this playback, the communication device is meanwhile optionally taking its usual actions to request and begin receiving the desired streaming content. This process 100 therefore also optionally provides for receiving 109 and playing back such streaming content as it is received via the communication channel.

If desired, this process 100 will readily accommodate other embellishments. For example, one can provide 110 a user-discernable display to provide information regarding present playability of the streaming content in response to local pre-caching of the determined amount of streaming content. This, in turn, would permit a user to know when relatively instant playback might be expected and when a delay might ordinarily be expected.

FIG. 3 provides an illustrative example 300 that accords with portions of these teachings. In this example, upon detecting that content streaming is likely to occur (as denoted by reference numeral 301), the communication device can determine an amount of streaming content to pre-cache and transmit a request 302 to the streaming content server and indicate a request for that determined amount of streaming content. The communication device will then receive and pre-cache the download of the requested amount of streaming content 303 (represented here by the initial portion of the streaming content as suggested by the letters “a-b-c”).

Some time later, upon receiving a command 304 from a user to begin streaming the content in question, the communication device can begin to play back 305 the pre-cached previously streamed data while also transmitting a request 306 to the streaming content server to begin streaming the requested content. In this example, the streaming content server begins streaming from around where the initial download ended. This can be achieved, for example, by having the communication device provide a suitable instruction or information to the streaming content server regarding the previously streamed content or by having the streaming content server be independently aware of such information (by maintaining or having access to a historical record of previous streaming events, for example).

In this example, at about the time the pre-cached streamed content concludes, the communication device becomes capable of rendering the newly received streaming content 307 (represented here by the letters “d-e-f-g-h . . . ”). This example may help the interested reader to more readily appreciate that these teachings are able to provide streaming content playback as an almost immediate response to when a user makes a specific request for such information notwithstanding a real and potentially lengthy delay before such streaming content can actually reach the communication device and become playable. Furthermore, in at least many instances the arrival of fresh streaming content should coincide with, or somewhat precede, the conclusion of the playback of the pre-cached content. This, in turn, will permit an essentially seamless playback experience for the user.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform will now be provided.

In this illustrative embodiment, a communication device 400 such as a two-way wireless communication device of choice comprises a streaming content playback platform 401 that operably couples to a streaming content download actuator 402 and a memory 403. The memory 403 serves, at least in part, to store a pre-cached initial incomplete portion of a given streaming content selection. This pre-cached data can comprise, for example, a pre-cached incomplete streaming content 404 in an amount as corresponds to a likely period of delay between actuation of the downloading streaming content process (as initiated, for example, via the streaming content download actuator 402) and being able to begin playing downloaded streaming content using the streaming content playback platform 401. The pre-cached data can also comprise, if desired, additional pre-cached streaming content 405 in an amount as corresponds to a period of time that will bridge a gap between the aforementioned likely period of delay and a potential less favorable period of delay as described above. As also noted above, this additional pre-cached streaming content 405 may have an intentionally reduced quality as compared to the pre-cached incomplete streaming content 404.

So configured, this communication device 400 can respond to assertion of the streaming content download actuator 402 (via, for example, a corresponding user interface) by beginning substantially immediate playback of the pre-cached incomplete streaming content 404 via the streaming content playback platform 401 notwithstanding that the communication device 400 has not yet begun to receive a current stream of content. To further aid in facilitating such teachings, if desired, this communication device 400 can further comprise a pre-cache determination platform 406 and a transceiver 407 that operably couples thereto and also to the memory 403 and the streaming content playback platform 401. So configured, the pre-cached determination platform 406 can be configured and arranged as per these teachings to determine an amount of the streaming content to locally pre-cache prior to detecting an instruction to download the streaming content for playback and to facilitate the acquisition of that streaming content amount and the retention of that streaming content as the pre-cached incomplete streaming content 404 (and optionally the additional pre-cached streaming content 405) in the memory 403.

Those skilled in the art will recognize and understand that such an apparatus 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

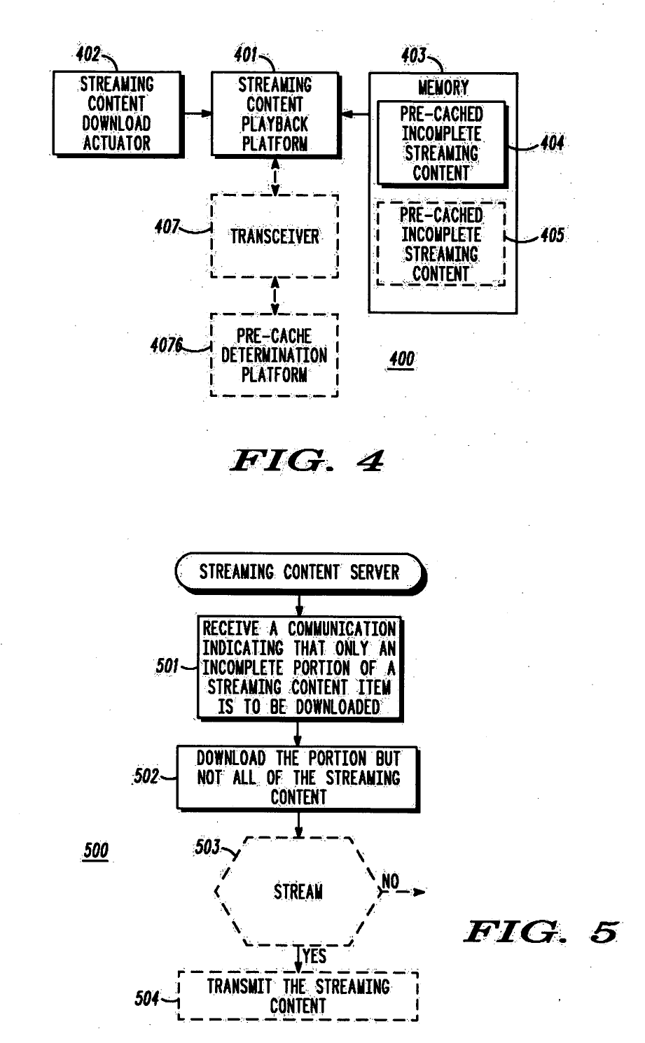

By one approach the streaming content server that sources the streaming content in the above examples comprises a knowing and facilitating participant with respect to these teachings. To aid in this regard, and referring now to FIG. 5, a streaming content server can be optionally configured and arranged to, upon receiving 501 a communication from a communication device that indicates that only an incomplete portion of a particular item of streaming content is to be downloaded to the communication device, responsively download 502 to that communication device that incomplete portion of the particular item of streaming content but not all of the particular item of streaming content. By one approach, and as per these teachings, this incomplete portion comprises an initial portion of the streaming content to thereby readily permit the communication device to be able to begin playback of the particular item of streaming content without undue delay.

As noted above, this incomplete portion may comprise an amount of streaming content that corresponds to a likely period of delay and/or can further include an additional amount as a safety measure. When providing additional surplus content, if desired, the latter can be provided at a lower level of quality as compared to the initial amount of streaming content.

Later, if desired, and upon detecting 503 a subsequent communication from the communication device to now facilitate streaming the complete particular item of streaming content to the communication device, this process 500 can optionally provide for downloading the requested content by transmitting 504 to this communication device a remaining portion of the particular item of streaming content (that is, a remaining portion of the streaming content other than the incomplete portion as was earlier provided to the communication device). If desired, of course, this download could comprise the complete item of streaming content though this practice may, at least under certain operating conditions, be wasteful of network resources and/or increase the quantity of streaming content as may need to be initially pre-cached at the communication device.

So configured, a playback apparatus such as a communication device will, at least from time to time, be able to substantially immediately respond to a user request for streaming content by initiating playback of the requested streaming content. Notwithstanding this pre-placement of potentially needed content, these teachings do not necessarily require undue memory capacity nor do these teachings necessarily require undue network resources. As a result, in general, the user experience can be significantly improved without necessarily requiring a significant upgrade in local or network resources and capacity.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, these teachings could be employed in conjunction with a streaming content server that is not configured as described herein and where the communication device simply stops storing streaming content when the predetermined amount has been received in order to have that predetermined amount available to employ as described above.

As another example, additional steps can be added to permit the full or partial removal of pre-cached streaming content notwithstanding non-use of that pre-cached streaming content. This may occur in a relatively fixed manner (for example, following expiration of a particular predetermined period of time) or may be accommodated in a more dynamic fashion as may best suit the needs or limitations of a given application setting. As another example in this regard, such removal can be triggered, at least in part, as a function of remaining memory capacity. As available memory diminishes, say, beyond a particular amount, all or portions of pre-cached streaming content can be deleted to provide room for additional downloaded content. By one approach, if desired, this action can comprise deleting only latter portions of pre-cached streaming content such that an initial portion still remains available for use as per these teachings. Also if desired, additional compression can be applied to pre-cached streaming content in response to such triggers as are presented above.

We claim:

1. A method comprising:
at a communication device:
responding to detection of a likely streaming content downloading event by dynamically determining an amount of the streaming content to locally pre-cache prior to detecting an instruction to download the streaming content to provide a determined amount;
locally pre-caching the determined amount of the streaming content.

2. The method of claim 1 wherein dynamically determining an amount of the streaming content to locally pre-cache comprises determining the amount as a function, at least in part, of a likely period of delay between detecting the instruction to download the streaming content and being able to begin providing the streaming content to a user of the mobile communication device.

3. The method of claim 2 wherein determining the amount as a function, at least in part, of a likely period of delay further comprises determining a determined amount of delay as corresponds to at least one of:
acquiring a wireless communication channel;
network message propagation latency;
streaming content server response latency;
jitter buffer filling;
playout buffer filling.

4. The method of claim 2 wherein determining the amount as a function, at least in part, of a likely period of delay between detecting the instruction to download the streaming content and being able to begin providing the streaming content to a user of the communication device further comprises determining both a likely period of delay and a potential less favorable period of delay.

5. The method of claim 4 wherein determining an amount of the streaming content to locally pre-cache further comprises determining an additional amount of the streaming content to locally pre-cache as corresponds to a difference between the potential less favorable period of delay and the likely period of delay.

6. The method of claim 5 wherein locally pre-caching the determined amount of the streaming content further comprises locally pre-caching the additional amount of the streaming content.

7. The method of claim 6 wherein locally pre-caching the additional amount of the streaming content further comprises locally pre-caching streaming content having intentionally reduced quality as compared to the determined amount of the streaming content.

8. The method of claim 1 further comprising:
detecting an instruction to download the streaming content;
substantially immediately responding to detecting the instruction to download the streaming content by beginning to play back the locally pre-cached streaming content prior to beginning to receive downloaded streaming content via a communication channel.

9. The method of claim 8 further comprising:
receiving the streaming content via the communication channel;
playing back the streaming content as is received via the communication channel.

10. The method of claim 8 wherein detecting an instruction to download the streaming content further comprises:
determining whether the streaming content can now likely begin to be received at the communication device within a useful period of time;
when the streaming content can not likely begin to be received at the communication device with a useful period of time, not substantially immediately responding by beginning to play back the locally pre-cached streaming content prior to beginning to receive downloaded streaming content via a communication channel.

11. The method of claim 1 further comprising:
transmitting a message indicating the determined amount of the streaming content.

12. The method of claim 1 further comprising:
providing a user-discernable display providing information regarding present playability of the streaming content in response to locally pre-caching the determined amount of the streaming content.

13. A communication device comprising:
a memory having a pre-cached initial incomplete portion of streaming content stored therein;
a streaming content download actuator;
a streaming content playback platform operably coupled to the memory and the streaming content download actuator and being configured and arranged to begin playing the pre-cached initial incomplete portion of streaming content in response to actuation of a downloading streaming content process by the streaming content download actuator.

14. The communication device of claim 13 wherein the pre-cached initial incomplete portion of streaming content comprises an amount of data as corresponds to a likely period of delay between the actuation of the downloading streaming content process and being able to begin playing downloaded streaming content using the streaming content playback platform.

15. The communication device of claim 14 wherein the pre-cached initial incomplete portion of streaming content further comprises an additional amount of data as corresponds to a potential less favorable period of delay between the actuation of the downloading streaming content process and being able to begin playing downloaded streaming content using the streaming content playback platform.

16. The communication device of claim 15 wherein the additional amount of data comprises streaming content having intentionally reduced quality as compared to the amount of data as corresponds to the likely period of delay.

17. The communication device of claim 13 further comprising:
means operably coupled to the memory and for determining an amount of the streaming content to locally pre-cache prior to detecting an instruction to download the streaming content for playback to provide a determined amount of the streaming content and for facilitating local pre-caching of the determined amount of the streaming content as the pre-cached initial incomplete portion of streaming content.

18. A method comprising:
receiving a communication from a communication device indicating that only an incomplete portion of a particular item of streaming content is to be downloaded to the communication device;
downloading to the communication device the incomplete portion of the particular item of streaming content but not all of the particular item of streaming content in response to the communication.

19. The method of claim 18 wherein the incomplete portion of the particular item of streaming content comprises an initial portion of the streaming content.

20. The method of claim 19 further comprising:
receiving a subsequent communication from the communication device to facilitate streaming the complete particular item of streaming content to the communication device;
downloading to the communication device a remaining portion of the particular item of streaming content other than at least a portion of the incomplete portion of the particular item of streaming content.
